(19) United States
(12) Patent Application Publication
(10) Pub. No.: US 2016/0179989 A1
(43) Pub. Date: Jun. 23, 2016

(54) Analysis Device, Analysis Method, and Program

(71) Applicant: Yazaki Corporation, Tokyo (JP)

(72) Inventors: Yoshinori Nakamura, Makinohara-shi (JP); Satoru Goto, Makinohara-shi (JP)

(73) Assignee: Yazaki Corporation, Tokyo (JP)

(21) Appl. No.: 15/058,201

(22) Filed: Mar. 2, 2016

Related U.S. Application Data
(63) Continuation of application No. PCT/JP2014/072654, filed on Aug. 28, 2014.

(30) Foreign Application Priority Data
Sep. 2, 2013 (JP) 2013-181373

(51) Int. Cl. G06F 17/50; B60R 16/02; H01B 7/18; H01B 7/00

(52) U.S. Cl. CPC G06F 17/50; H01B 7/0045; B60R 16/0215; H01B 7/184; G06F 17/5095

(57) ABSTRACT

A form of a wire harness including a corrugated tube in which a cylindrical portion in a shape of a hollow cylinder and a bellows portion that has side walls in which projected folds and recessed folds are repeated alternately and of which the inside is surrounded by the side walls and is in a hollow shape are connected and an electric wire positioned inside the corrugated tube is image-constructed by arithmetic operation.

### CROSS REFERENCE TO RELATED APPLICATIONS

This application is a continuation of international patent application No. PCT/JP2014/072654 filed Aug. 28, 2014 based on Japanese Patent Application No. 2013-181373 filed Sep. 2, 2013; the contents of which are incorporated herein by reference in its entirety.

### BACKGROUND OF THE INVENTION

1. Field of the Invention

The present invention relates to an analysis device, an analysis method, and a program in which a form of a wire harness including a corrugated tube and an electric wire positioned inside the corrugated tube is image-constructed by arithmetic operation.

2. Description of the Related Art

Before an actual wire harness is manufactured, a virtual wire harness is modeled in a computer, and the virtual wire harness is reviewed at a design stage. An example of this type of simulation is disclosed in JP-A-2003-132102 as Patent Literature 1 and JP-A-2009-181746 as Patent Literature 2.

Patent Literature 1; JP-A-2003-132102

Patent Literature 2; JP-A-2009-181746

### SUMMARY OF THE INVENTION

The applicant assumes that in modeling the virtual wire harness in the computer and reproducing the modeled wire harness in a state the form of the wire harness is visible, the simulation is performed as follows. That is, first, one model is determined as the wire harness. At this point, for example, in a case where the wire harness is configured from an electric wire, a connector, a clamp, and a corrugated tube, a condition that stipulates the electric wire, such as a physical property value that is specified by a diameter or a length of the electric wire, the number of wires, or a material of the electric wire, is given as an initial parameter, a condition that stipulates the connector, such as a physical property value that is specified by a form of the connector, a position on the electric wire, at which the connector is attached, or a material of the connector, is given as an initial parameter, a condition that stipulates the clamp, such as a physical property value that is specified by a form of the clamp, a position on the electric wire, at which the clamp is attached, or a material of the clamp, is given as an initial parameter, and a condition that stipulates the corrugated tube, such as a physical property value that is specified by an internal diameter, an external diameter, a length, or a material of the corrugated tube, is given as an initial parameter.

Next, given coordinates are assigned to the connector and the clamp with respect to one model that is determined in this manner, and coordinates at which each element that constitutes the electric wire and the corrugated tube is positioned are calculated based on a condition that stipulates a certain element or a relationship between elements. At this point, the given coordinates that are assigned to the connector and the clamp are equivalent to three-dimensional coordinates at which the connector and the clamp that are attached to the panel are positioned, in an arranged-to-run environment in which, through the clamp, the wire harness is arranged to run in a vehicle panel. Furthermore, for the condition that stipulates a certain element or the relationship between elements, a physical phenomenon, in accordance with which each element of the modeled wire harness has to behave, such as an influence due to gravity that acts on each element, an influence due to stress that acts on each element, an influence due to elastic force that adjacent elements exert on each other, a boundary condition, or the like, is formulated as a fundamental equation.

In this manner, coordinates at which each element that constitutes an electric wire and a corrugated tube is positioned is calculated in a case where a position of the modeled wire clamp is determined, and thus in one model, forms of the electric wire and the corrugated tube are specified in one arranged-to-run environment.

Incidentally, in modeling the wire harness and reproducing a form of the modeled wire harness, it is required that various wire harnesses having different structures be modeled and the form of each modeled wire harness be constructed. Furthermore, it is required that a wire harness with a certain structure be applied to various arranged-to-run environments that are different from each other and that the form of the wire harness is constructed. In a situation where the construction of the form of the wire harness has to be performed multiple times in this manner, it is preferable that the time required for one-time analysis is shortened without increasing a precision error between the form that results when the modeled wire harness is installed to run in a certain arranged-to-run environment and the form that results when an actually manufactured wire harness is installed to run in the same arranged-to-run environment.

An object of the present invention, which is made in view of the situations described above, is to provide an analysis device, an analysis method, and a program, in which the time required for one-time analysis can be shortened without increasing a precision error between a form that results when a modeled wire harness is installed to run in a certain arranged-to-run environment and a form that results when an actually manufactured wire harness is installed to run in the same arranged-to-run environment.

In order to accomplish the object described above, the analysis device according to the present invention has characteristics as in the configuration (1) and (2) described below.

(1) An analysis device that image-constructs a form of a wire harness by arithmetic operation, the wire harness including a corrugated tube in which a cylindrical portion in a shape of a hollow cylinder, and a bellows portion that has side walls in which projected folds and recessed folds are repeated alternately and of which the inside is surrounded by the side walls and is in a hollow shape are connected and the wire harness further including an electric wire positioned inside the corrugated tube, the analysis device including:

a storage unit in which physical property values of elements that are a part of the cylindrical portion, physical property values of elements that are a part of the bellows portion and physical property values of elements that are a part of the electric wire in a modeled wire harness are stored on element basis;

a recording unit in which a program that implements an analysis step that is based on a condition which stipulates a certain element or a relationship between elements is recorded; and

an arithmetic operation unit that calculates, for all elements, coordinates of any elements when a given element is positioned at given coordinates, and constructs an image in which forms of the corrugated tube and the electric wire are expressed based on the calculated coordinates of some or all of the elements, by referring to the physical property values on the element basis stored in the storage unit and the program recorded in the recording unit, wherein

the physical property value of the elements that are the part of the cylindrical portion is a numerical value approximating that the cylindrical portion is a rigid body not to be bent.

(2) The analysis device for evaluating performance of the wire harness of which the form is calculated by the analysis device according to the configuration (1), wherein

the physical property values of elements that are a part of the cylindrical portion, the physical property values of elements that are a part of the bellows portion and the physical property values of elements that are a part of the electric wire are stored on element basis and also an external additional condition that is externally given on the wire harness in order to evaluate the performance is further stored in the storage unit, and

the arithmetic operation unit calculates the performance in a case where the external additional condition is given to the wire harness, by referring to the physical property values on the element basis and the external additional condition, which are stored in the storage unit, and the program recorded in the recording unit, and outputs the calculated performance.

With the analysis device that is configured in (1) described above, the time required for one-time analysis can be shortened without decreasing the analysis precision.

With the analysis device that is configured in (2) described above, evaluation of the performance of the wire harness is performed on the wire harness which is image-constructed by the analysis device of the present invention. Accordingly, the time required for one consecutive process from the reproduction of the form of the wire harness to the evaluation of the performance of the wire harness.

In order to accomplish the object described above, the analysis method according to the present invention has a characteristic as in the configuration (3) described below.

(3) An analysis method that image-constructs a form of a wire harness by arithmetic operation, the wire harness including a corrugated tube in which a cylindrical portion in a shape of a hollow cylinder, and a bellows portion that has side walls in which projected folds and recessed folds are repeated alternately and of which the inside is surrounded by the side walls and is in a hollow shape are connected and the wire harness further including an electric wire positioned inside the corrugated tube, the analysis method including:

calculating, for all elements, coordinates of any elements when a given element is positioned at given coordinates, by referring to physical property values of elements that are a part of the cylindrical portion, physical property values of elements that are a part of the bellows portion and physical property values of elements that are a part of the electric wire, and a program that implements an analysis step that is based on a condition which stipulates a certain element or a relationship between elements; and

constructing an image in which forms of the corrugated tube and the electric wire are expressed based on the calculated coordinates of some or all of the elements, wherein

the physical property value of the elements that are the part of the cylindrical portion is a numerical value approximating that the cylindrical portion is a rigid body not to be bent.

In order to accomplish the object described above, the program according to the present invention has a characteristic in the configuration (4) described below.

(4) A program for causing a computer to carry out each step that is included in the analysis method configured in (3) described above.

With the analysis method that is configured in (3) described above or the program that is configured in (4) described above, the time required for one-time analysis can be shortened without decreasing the analysis precision.

With an analysis device, an analysis method, and a program according to the present invention, the time required for one-time analysis can be shortened without increasing a precision error between a form that results when a modeled wire harness is installed to run in a certain arranged-to-run environment and a form that results when an actually manufactured wire harness is installed to run in the same arranged-to-run environment.

The present invention is briefly described above. Additionally, if a mode (hereinafter referred to as an “embodiment”) for implementing the present invention that will be described below is perused referring to the accompanying drawings, the details of the present invention will be made more definite.

### BRIEF DESCRIPTION OF THE DRAWINGS

FIG. 1 is a conceptual diagram for describing an overview of a design technique for a wire harness that is assumed according to an embodiment of the present invention.

FIG. 2A is a side-view diagram illustrating the wire harness that is applied according to the embodiment of the present invention.

FIG. 2B is a cross-sectional diagram taken along line IIB-IIB in FIG. 2A.

FIGS. 3A and 3B are diagrams illustrating a form of the wire harness that is reproduced according to the embodiment of the present invention.

FIG. 4 is a diagram illustrating the wire harness that is reproduced according to the embodiment of the present invention and that is arranged to run in a vehicle body panel.

FIG. 5 is a block diagram illustrating a hardware configuration of an analysis device according to the embodiment of the present invention.

### DETAILED DESCRIPTION OF THE EXEMPLARY EMBODIMENTS

A specific embodiment of the present invention will be described below referring to the drawings.

### Overview of Design Technique of Wire Harness that is Assumed According to an Embodiment of the Present Invention

First, in order to help with an understanding of the embodiments of the present invention, a description is provided for an overview of a design technique for a wire harness that is assumed according to the embodiment of the present invention. Moreover, an analysis device, an analysis method and a program according to the present invention can be applied not only to the design technique for the wire harness that will be described from now on, but can also be applied to various design techniques that are different in design concept. Therefore, the analysis device, the analysis method, and the program according to the present invention are not limited to the design technique for the wire harness that will be described from now on.

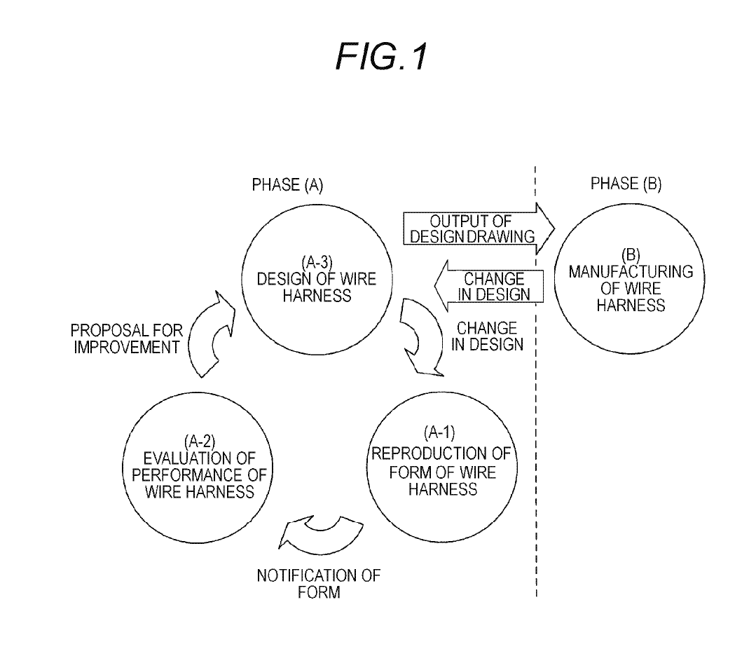

FIG. 1 is a conceptual diagram for describing an overview of a design technique for a wire harness that is assumed according to the embodiment of the present invention.

The design technique for the wire harness that is illustrated in FIG. 1 is broadly divided into two phases. One is a phase (A) and the other is a phase (B). The first phase (A) is a phase in which quality of the wire harness is checked and a design drawing of a suitable wire harness starts to be created. The second phase (B) is a phase in which the wire harness is manufactured based on the design drawing that is obtained in the phase (A). Additionally, the phase (A) includes a step (A-1) in which a form of the wire harness is specified and the form is image-constructed by arithmetic operation processing, a step (A-2) in which performance of the wire harness of which the form is specified is evaluated, and a step (A-3) in which the wire harness is designed considering a result of the evaluation in the step (A-2) and a cause of an error that occurs in manufacturing. The step (A-1) to the step (A-3) are repeated without any interruption in this sequence: the step (A-1), the step (A-2), and the step (A-3). Verification is performed in each step, and thus a higher-quality wire harness is designed. In this way, the design drawing of the wire harness that is generated in the step (A-3) is sent to the step (B), and in the step (B), the wire harness is manufactured as an object based on the design drawing of the wire harness. The design concept behind the design technique is to create an environment in which the wire harness is manufactured without performing verification that uses an actual wire harness. For this reason, quality checking that is performed in the step (A-1) to the step (A-3) is all performed by a computer. The step (A-1) to the step (A-3) will be described in detail below.

First, the step (A-1) is described. The step (A-1) is a step of which an object is for an analyst to visually recognize the form (the expression the “form of wire harness” is hereinafter defined as referring to a form of the wire harness that is bent along a wiring path when the wire is arranged to run in a vehicle body panel) of the wire harness. It is visually recognized in the step (A-1) that the form of the wire harness is reproduced and is analyzed, and thus the analyst is urged to specify a defective portion (for example, an excessively-long or excessively-short length of an electric wire, excessive curvature or twist of an electric wire or a corrugated tube, or the like). Moreover, a method of image-constructing the form of the wire harness by performing the arithmetic operation processing will be described in detail below.

Next, the step (A-2) is described. The step (A-2) is a step of which an object is to evaluate an influence that an external environment exerts on the wire harness in a state where the wire harness is arranged to run in the vehicle body panel. In the step (A-2), an external additional condition from the outside is given on the wire harness of which the form is specified in the step (A-1), and the arithmetic operation processing is again performed on the form of the wire harness. Thus, the influence that the external additional condition exerts on the performance of the wire harness is evaluated. Incidentally, in the step (A-1), a defect in the wire harness that occurs due to an internal environment, to be more precise, a defect in the wire harness that occurs due to the curvature of the wire harness itself is specified. On the one hand, in the step (A-2), a defect in the wire harness that occurs due to an external environment, to be more precise, a defect in the wire harness that occurs due to various loads that the vehicle body panel in which the wire harness is arranged to run imposes on the wire harness is specified. In the step (A-2), for example, a distance between the wire harness and the vehicle body panel in which the wire harness is arranged to run is evaluated, and durability of the wire harness is evaluated by creating an environment such as when providing vibration to a clamp on the assumption of a situation in which vibration resonates, or providing vibration to an electric wire on the assumption of a situation where a clamp shakes.

Last, the step (A-3) is described. In the step (A-3), the result of the evaluation that is performed in the step (A-2), a functional requirement for the wire harness, which is designated by a customer, and the cause of the error (dimensional tolerance that occurs in manufacturing are considered, tolerance for the vehicle body panel, or the like) that occurs in manufacturing are considered, the optimal wire harness is determined, and the design drawing thereof starts to be created. In a case where a structure of the wire harness that is determined as being optimal in the step (A-3) is changed from a structure of the wire harness that is modeled in the step (A-1), the step (A-1) to the step (A-3) are again performed, and the quality of the wire harness is checked. On the other hand, in a case where a great change to the structure of the wire harness that is modeled in the step (A-1) is not made, the design drawing starts to be created. Then, the design drawing of the wire harness that is generated in the step (A-3) is sent in the step (B), and the wire harness is manufactured as an object based on the design drawing thereof in the step (B). Moreover, it is also considered that a change to the design occurs in the step (B). In this case, details of the change are passed on to the step (B) to the step (A-3) of the phase (A), the step (A-1) to the step (A-3) are again performed, and the quality of the wire harness is checked.

According to the flow that is described above, the design drawing is formed and the wire harness is manufactured based on the design drawing thereof. This design technique is not one in which a prototype of a wire harness is produced and then the wire harness is evaluated through the prototype. For this reason, effort, cost, and time necessary for the design of the wire harness can be reduced as much as they are necessary for producing the prototype. Additionally, because the quality of the wire harness with various structures is checked, a wire harness that, among various harnesses, is suitable for a customer need can be proposed. The overview of the design technique of the wire harness that is assumed according to the embodiment of the present invention is described above.

However, if a higher-quality wire harness is required, it is of course required that various wire harnesses with different structures be modeled, and a form of each wire harness that is modeled be checked. As a result, the arithmetic operation processing time increases greatly in the phase (A) described above. Accordingly, according to the embodiment of the present invention, an algorithm is described in which, an arithmetic operation processing amount in the step (A-1) for reproducing the form of the wire harness is reduced in order to decrease the arithmetic operation processing time in the phase (A).

[Structure of the Wire Harness]

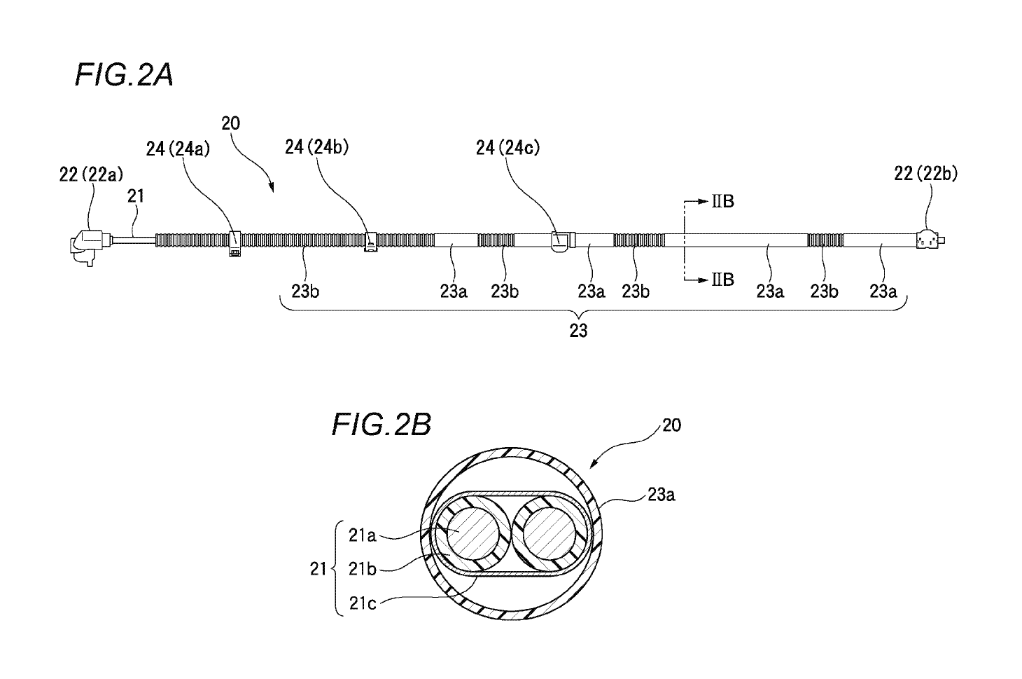

The structure of the wire harness that is applied according to the embodiment of the present invention is described. FIG. 2A is a side-view diagram illustrating the wire harness that is applied according to the embodiment of the present invention. FIG. 2B is a cross-sectional diagram taken along line IIB-IIB in FIG. 2A.

A wire harness 20 of which a form is specified by the analysis device, the analysis method, and the program according to the embodiment of the present invention is configured to include an electric wire 21, a connector 22, a corrugated tube 23, and a clamp 24.

The electric wire 21 is a high voltage cable. The electric wire 21, as illustrated in FIG. 2B, is configured from two internal conductors 21a that are arranged adjacent to each other, an external covering 21b that covers a periphery of the internal conductor 21a and that is provided to each internal conductor 21a, and an external conductor 21c within which the two internal conductors 21a of which the peripheries are covered with the external covering 21b are accommodated. The connector 22 is connected to both ends of the electric wire 21 that is configured in this manner. Furthermore, the electric wire 21 is arranged in such a manner that the electric wire 21 is positioned within the corrugated tube. Moreover, according to the present embodiment of the present invention, the electric wire 21 is described as being the high voltage cable, but the present invention can be applied not only to the wire harness that includes a high voltage cable, but also to the wire harness that includes various electric cables. For this reason, the wire harness of which the form is specified according to the present invention is not limited to the inclusion of the high voltage cable.

The connector 22 is configured from an inverter connector 22a that is connected to one end of the electric wire 21 and a device connector 22b that is connected to the other end of the electric wire 21, and that is linked to various devices. The present invention can be applied not only to the wire harness that includes the connector 22, but also to the wire harness that includes various connectors. For this reason, the wire harness of which the form is specified according to the present invention is not limited to the inverter connector 22a and the device connector 22b.

The corrugated tube 23 is obtained by connecting a cylindrical portion 23a in the shape of a hollow cylinder, and a bellows portion 23b that has side walls in which projected folds and recessed folds are repeated alternately and of which the inside is surrounded by the side walls and is in the shape of a hollow circle. Lengths of the cylindrical portion 23a and the bellows portion 23b that extend in a longitudinal direction are suitably changed. The corrugated tube 23 is different from the corrugated tube in that the corrugated tube 23 is configured to include the cylindrical portion 23a in the shape of a hollow cylinder. In other words, the corrugated tube is formed by only the bellows portion 23b of the corrugated tube 23 in terms of structure. The clamp 24 is fixed to a periphery of the corrugated tube 23. In the corrugated tube 23 with this structure, the cylindrical portion 23a has higher rigidity than the bellows portion 23b, and the bellows portion 23b has higher flexibility than the cylindrical portion 23a. As a result, it is possible to bend only at a given position, that is, at the bellows portion 23b. The present inventors has focused on the high rigidity of the cylindrical portion 23a, and has concluded to reduce the arithmetic operation processing amount in the step (A-1) for reproducing the form of the wire harness.

The clamp 24 is a member for attaching the corrugated tube 23 to the vehicle body panel. The clamp 24 is obtained by forming a holding portion that holds a periphery of the corrugated tube 23 and an engagement portion that is engaged with a mounting hole into one piece. As illustrated FIG. 2A, according to the embodiment of the present invention, three clamps, that is, clamps 24a, 24b, and 24c in this order from a direction of the inverter connector 22a are fixed to the corrugated tube 23. The clamps 24a, 24b, and 24c that are fixed to the corrugated tube 23 are attached to the mounting hole in the vehicle body holes, and thus the corrugated tube 23 is arranged to run in the vehicle body panel through the clamps 24a, 24b, and 24c. Moreover, according to the embodiment of the present invention, the clamp is described as a fixing tool for arranging the corrugated tube 23 to run in the vehicle body panel, but the present invention can be applied not only to the wire harness that includes the clamp, but also the wire harness that includes, for example, a grommet, a clip, or the like. For this reason, the wire harness of which the form is specified according to the present invention is not limited to the inclusion of the clamp.

[Algorithm for Image-constructing the Form of the Wire Harness]

Subsequently, the step (A-1) of the phase (A) described above, to be more precise, the method of image-constructing the form of the wire harness by performing the arithmetic operation processing is described in detail. According to the embodiment of the present invention, modeling of the wire harness using a finite element method and calculation of the form of the wire harness are assumed. Moreover, according to the embodiment of the present invention, a case where the finite element method is applied as a numerical analysis method is described, but the algorithm for image-constructing the form of the wire harness according to the present invention is not limited to the algorithm based on the finite element method.

[Modeling of the Wire Harness]

At this point, the structure of the wire harness 20, which is described referring to FIGS. 2A to 2B is modeled in such a manner that numerical analysis is possible with the finite element method. A target for modeling, as illustrated in FIG. 2A, is the wire harness that extends in a straight line without a curvature portion. A dimension of each of the electric wire 21, the connector 22, the corrugated tube 23, and the clamp 24 that constitute the wire harness 20 is set as a condition, and a structure of each member is subdivided by an element (mesh).

Additionally, a physical property value is assigned to each element in each member. The physical property value is a parameter that is substituted into a fundamental equation that formulates a physical phenomenon, in accordance with which each element has to behave, in specifying the form of the wire harness by performing the numerical analysis. With regard to the electric wire 21, an intrinsic physical property value is assigned to each of the internal conductor 21a, the external covering 21b, and the external conductor 21c. With regard to the connector 22, an intrinsic physical property value is assigned to each of the members, such as a terminal, a housing, and a shield, that constitute the inverter connector 22a or the device connector 22b. With regard to the corrugated tube 23, an intrinsic physical property value is assigned to each of the cylindrical portion 23a and the bellows portion 23b. With regard to the clamp 24, an intrinsic physical property value is assigned to each of the holding portion and the engagement portion.

In the embodiment of the present invention, a numerical value indicating that rigidity is extremely high is especially assigned to the cylindrical portion 23a.

[Calculation of the Form of the Wire Harness that is Arranged to Run in the Vehicle Body Panel]

Next, the form of the wire harness that is arranged to run in the vehicle body panel is specified by performing the numerical analysis, using the wire harness that is modeled as described above, that is, the hard harness in which the structure of each member is subdivided by the element and in which the physical property value is assigned to each element in each member. The algorithm for numerically analyzing the form of the wire harness using the finite element method is disclosed in, for example, JP-A-2009-205401. According to the embodiment of the present invention, this type of algorithm is basically applied and the form of the wire harness is calculated.

Now, in order to specify the form of the wire harness with the algorithm described above, there is a need to reproduce a situation where the wire harness is arranged to run in the vehicle body panel and to calculate the form of the wire harness in such a situation. In order to reproduce the situation, the following external condition is given to the wire harness, and the form of the wire harness that is bent is sequentially calculated by performing the numerical analysis that complies with the algorithm described above, in such a manner that the condition is satisfied.

As illustrated in FIG. 2A, the wire harness that extends in a straight line without a curvature portion is in an initial situation of the form of the wire harness. More specifically, initial coordinates are assigned to each of the inverter connector 22a, the clamp 24a, the clamp 24b, the clamp 24c and the device connector 22b, in such a manner that the corrugated tube 23 is in a straight line.

Under this situation, first, an external condition for moving the inverter connector 22a toward given coordinates is given, and the form of the wire harness that is bent is sequentially calculated in such a manner that the condition is satisfied. The external condition is one that results from formalizing operations in which, when an actual wire is arranged to run in the vehicle body panel, an operator raises the inverter connector 22a and fits the inverter connector 22a to a counterpart connector. For this reason, the given coordinates toward which the inverter connector 22a is moved are coordinates at which the inverter connector 22a is positioned when engaged with the counterpart connector. The given coordinates are determined according to a structure of a vehicle body panel 40 which will be described below, and are stipulated in, for example, design specifications that are notified by a manufacturer of assembled products to suppliers. For this reason, given coordinates at which the inverter connector 22a is positioned are specified referring to the design specifications.

In a process of moving the inverter connector 22a to the given coordinates, an influence due to gravity acting on each element, an influence due to stress acting on each element, an influence due to elastic force that adjacent elements exert on each other, and the like are reflected in the form of the wire harness 20 by the algorithm described above. When the inverter connector 22a reaches the given coordinates, and a convergence condition for an arithmetic operation in the algorithm described above is satisfied, the movement of the inverter connector 22a is regarded as being completed, that is, the operation in which the operator raises the inverter connector 22a and the operation in which the operation fits the inverter connector 22a to the counterpart connector are regarded as being completed.

After the movement of the inverter connector 22a is completed, subsequently, an external condition for moving the clamp 24a to the given coordinates is given, and the form of the wire harness that is bent is calculated in such a manner that the condition is satisfied. The external condition is one that results from formalizing operations in which, when an actual wire is arranged to run in the vehicle body panel, the operator raises the clamp 24a and engages the clamp 24a with the mounting hole in the vehicle body panel. Therefore, the given coordinates toward which the clamp 24a is moved are coordinates at which the clamp 24a is positioned when engaged with the mounting hole in the vehicle body panel. The given coordinates are also determined according to the structure of the vehicle body panel 40 described later, and are stipulated in, for example, the design specifications that are notified by the manufacturer of assembled products to the suppliers. For this reason, given coordinates at which the clamp 24a is positioned are specified referring to the design specifications.

In a process of moving the clamp 24a to the given coordinates, an influence due to gravity acting on each element, an influence due to stress acting on each element, an influence due to elastic force that adjacent elements exert on each other, and the like are reflected in the form of the wire harness 20 by the algorithm described above. When the clamp 24a reaches the given coordinates, and the convergence condition for the arithmetic operation in the algorithm described above is satisfied, the movement of the clamp 24a is regarded as being completed, that is, the operation in which the operator raises the clamp 24a and the operation in which the operation engages the clamp 24a with the mounting hole in the vehicle body panel are regarded as being completed.

After the movement of the clamp 24a is completed, subsequently, as in the clamp 24a, an external condition for moving the clamp 24b to the given coordinates is given, and the form of the wire harness that is bent is calculated in such a manner that the condition is satisfied.

After the movement of the clamp 24b is completed, subsequently, as in the clamp 24a and the clamp 24b, an external condition for moving the clamp 24c to the given coordinates is given, and the form of the wire harness that is bent is calculated in such a manner that the condition is satisfied.

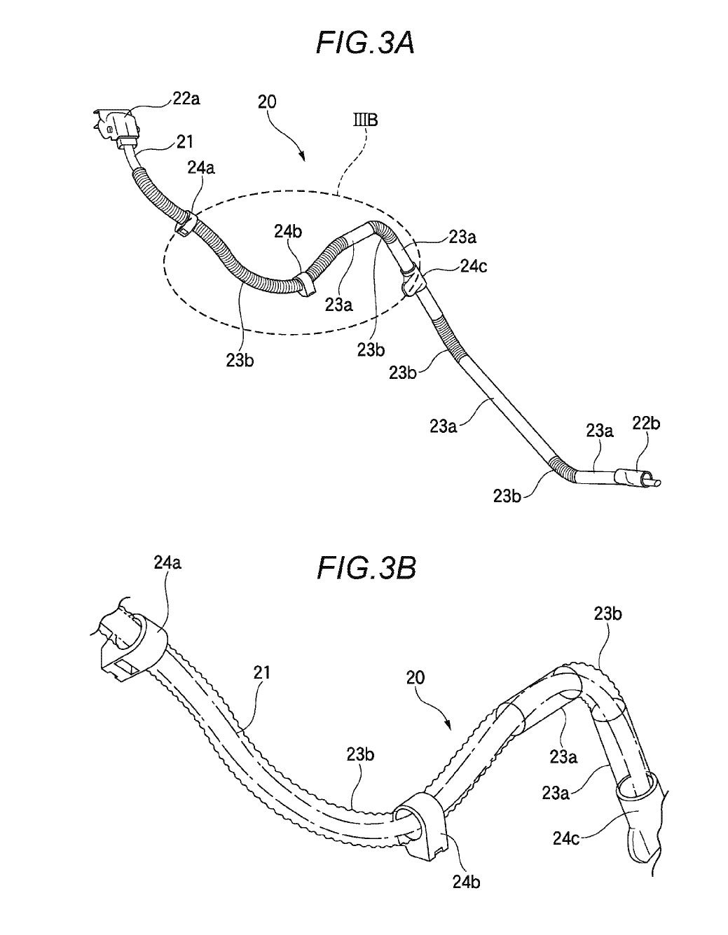

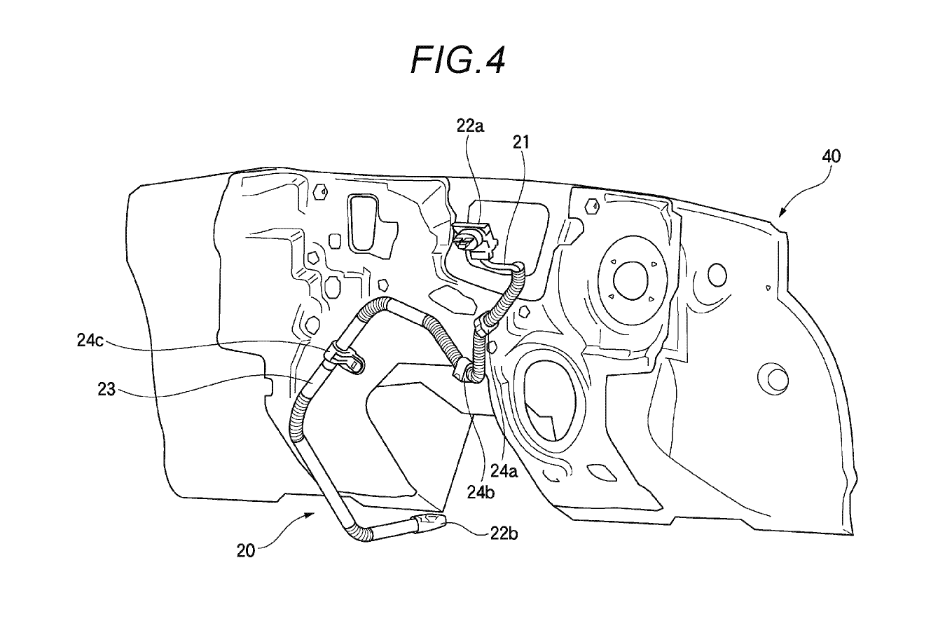

After the movement of the clamp 24c is completed, subsequently, as in the inverter connector 22a, an external condition for moving the device connector 22b to given coordinates is given, and the form of the wire harness that is bent is calculated in such a manner that the condition is satisfied. In this manner, the inverter connector 22a, the clamp 24a, the clamp 24b, the clamp 24c, and the device connector 22b are moved to given points in this order, and a situation where the wire harness is arranged to run in the vehicle body panel is reproduced. The shape of the wire harness 20 that results when the movement of the clamp 24a is completed is the form of the wire harness that is finally calculated. One example of the calculated form of the wire harness is illustrated in FIGS. 3A, 3B, and 4. FIGS. 3A and 3B are diagrams illustrating the form of the wire harness that is reproduced according to the embodiment of the present invention. FIG. 4 is a diagram illustrating the wire harness that is reproduced according to the embodiment of the present invention and that is arranged to run in the vehicle body panel. An image in which the form of the wire harness is expressed is constructed based on coordinates of some or all of pixels that are calculated in this manner.

Incidentally, as described in [Modeling of the Wire Harness], a numerical value indicating that rigidity is extremely high is assigned to the cylindrical portion 23a. Consequently, approximation in which the cylindrical portion 23a is assumed not to be bent is reflected in the algorithm described above in reproducing the situation where the wire harness is arranged to run in the vehicle body panel, and thus an arithmetic operation of calculating a form of the cylindrical portion 23a is omitted. For example, in an element by which the cylindrical portion 23a is subdivided, an arithmetic operation of calculating an influence due to elastic force that adjacent elements exert each other is omitted. For this reason, an amount of arithmetic operation relating to the cylindrical portion 23a is reduced.

The cylindrical portion 23a of the actual corrugated tube 23 has high rigidity, and is almost not bent when the wire harness 20 is arranged to run in the vehicle body panel. The step (A-1) is a process of specifying a defect in the wire harness the occurs due to the wire harness itself, but as long as the curvature of the cylindrical portion 23a of the corrugated tube 23 almost does not occur, it is considered that there is almost no concern that a defect caused by the cylindrical portion 23a will occur. For this reason, although the arithmetic operation of calculating the form of the cylindrical portion 23a is omitted, this exerts almost no influence on reproducibility of the form of the wire harness, and causes no problem.

As described above according to the embodiment of the present invention, in the algorithm for image-constructing the form of the wire harness, a numerical value indicating that the rigidity is extremely high is assigned to the cylindrical portion 23a, the approximation in which the cylindrical portion 23a is assumed not to be bent is reflected, and thus the arithmetic operation of calculating the form of the cylindrical portion 23a is omitted. For this reason, the time required for one-time analysis for image-constructing the form of the wire harness can be shortened. At this time, although the arithmetic operation of calculating the form of the cylindrical portion 23a is omitted, this exerts almost no influence on reproducibility of the form of the wire harness, and an error in the precision of the reproducibility can be tolerated in practice.

According to the embodiment of the present invention, the inverter connector 22a, the clamp 24a, the clamp 24b, the clamp 24c, and the device connector 22b are moved at givens points in this order, and the situation where the wire harness is arranged to run in the vehicle body panel is reproduced. For this reason, it can be said that the form of the wire harness is calculated as much as a total number (five times) of the connectors 22 and the clamps 24. In a case where the numerical value is analyzed in this way, it is found that each time required for calculating the form of the wire harness is shortened by omitting the arithmetic operation of calculating the form of the wire harness.

[Hardware Configuration]

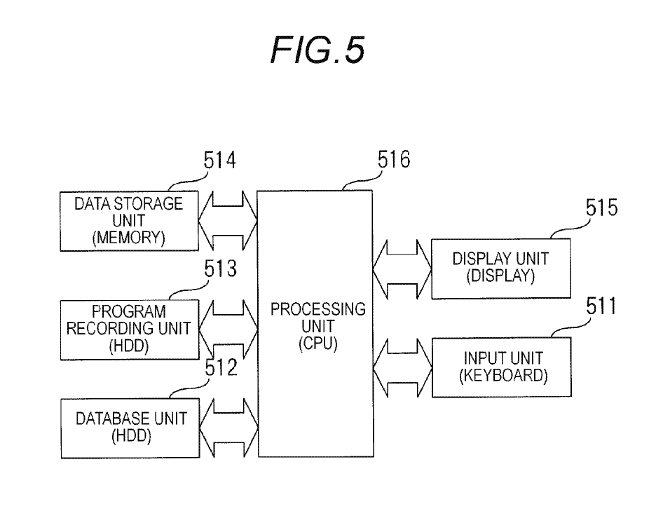

FIG. 5 is a block diagram illustrating a hardware configuration of the analysis device according to the embodiment of the present invention. The analysis device according to the embodiment of the present invention includes an input unit 511, a database unit 512, a program recording unit 513, a data storage unit 514, a display unit 515, and a processing unit 516. In a case where the analysis device according to the present invention is configured as, for example, a general-purpose computer, the input unit 511 is realized as various input interfaces such as a keyboard, a mouse, and a numeric keypad, the database unit 512 and the program recording unit 513 are realized as a hard disk drive (HDD), the data storage unit 514 is realized as a Random Access Memory (RAM), the display unit 515 is realized as various output devices such as a CRT display and a liquid crystal display, and the processing unit 516 is realized as a Central Processing Unit (CPU).

Included in the database unit 512 are pieces of information on forms and physical property values of the electric wire 21, the connector 22, the corrugated tube 23, and the clamp 24, which are used when the wire harness is modeled. Furthermore, the algorithm that is described in “Algorithm for Image-constructing the Form of the Wire Harness”, which is mentioned above is recorded in the program recording unit 513. Furthermore, data that is input and output into and from the processing unit 516 that performs the arithmetic operation that is described in “Calculation of the Form of the Wire Harness that is Arranged to Run in the Vehicle Body Panel” is recorded in the data storage unit 514. Particularly, an image in which the form of the wire harness that is finally calculated is expressed is written to the data storage unit 514.

The hardware configuration of the analysis device according to the embodiment of the present invention described above can be also applied in the step (A-2) of the phase (A). When the step (A-2) is implemented with the analysis device according to the embodiment of the present invention, information on the external additional condition is stored in the database unit 512 in addition to the information of the forms and the physical property values of the electric wire 21, the connector 22, the corrugated tube 23, and the clamp 24, which are used when the wire harness is modeled. Furthermore, the processing unit 516 performs the arithmetic operation that is explained in the step (A-2).

Moreover, the analysis device, the analysis method, and the program according to the present invention relate to the step (A-1) of the phase (A) in the overview that is described referring to FIG. 1, but various design techniques that are different in design concept can be applied. Therefore, the analysis device, the analysis method, and the program according to the present invention are not limited to the design technique in the overview that is described referring to FIG. 1.

At this point, characteristics of the analysis device, the analysis method, and the program according to the embodiment of the present invention, which are described above, will be individually listed in [1] to [4] in a briefly organized manner, as follows.

[1] An analysis device that image-constructs a form of a wire harness by arithmetic operation, the wire harness including a corrugated tube (23) in which a cylindrical portion (23a) in a shape of a hollow cylinder, and a bellows portion (23b) that has side walls in which projected folds and recessed folds are repeated alternately and of which the inside is surrounded by the side walls and is in a hollow shape are connected and the wire harness further including an electric wire (21) positioned inside the corrugated tube (23), the analysis device including:

a storage unit (a database unit 512) in which physical property values of elements that are a part of the cylindrical portion (23a), physical property values of elements that are a part of the bellows portion (23b) and physical property values of elements that are a part of the electric wire (21) in a modeled wire harness are stored on element basis;

a recording unit (a program recording unit 513) in which a program that implements an analysis step that is based on a condition which stipulates a certain element or a relationship between elements is recorded; and

an arithmetic operation unit (a processing unit 516) that calculates, for all elements, coordinates of any elements when a given element is positioned at given coordinates, and constructs an image in which forms of the corrugated tube and the electric wire (21) are expressed based on the calculated coordinates of some or all of the elements, by referring to the physical property values on the element basis stored in the storage unit (the database unit 512) and the program recorded in the recording unit (the program recording unit 513), wherein

the physical property value of the elements that are the part of the cylindrical portion (23a) is a numerical value approximating that the cylindrical portion (23a) is a rigid body not to be bent.

[2] The analysis device for evaluating performance of the wire harness of which the form is calculated by the analysis device according to the configuration [1], wherein

the physical property values of elements that are a part of the cylindrical portion (23a), the physical property values of elements that are a part of the bellows portion (23b) and the physical property values of elements that are a part of the electric wire (21) are stored on element basis and also an external additional condition that is externally given on the wire harness in order to evaluate the performance is further stored in the storage unit (the database unit 512), and

the arithmetic operation unit (the processing unit 516) calculates the performance in a case where the external additional condition is given to the wire harness, by referring to the physical property values on the element basis and the external additional condition, which are stored in the storage unit (the database unit 512), and the program recorded in the recording unit (the program recording unit 513), and outputs the calculated performance.

[3] An analysis method that image-constructs a form of a wire harness by arithmetic operation, the wire harness including a corrugated tube in which a cylindrical portion (23a) in a shape of a hollow cylinder, and a bellows portion (23b) that has side walls in which projected folds and recessed folds are repeated alternately and of which the inside is surrounded by the side walls and is in a hollow shape are connected and the wire harness further including an electric wire (21) positioned inside the corrugated tube, the analysis method including:

calculating, for all elements, coordinates of any elements when a given element is positioned at given coordinates, by referring to physical property values of elements that are a part of the cylindrical portion (23a), physical property values of elements that are a part of the bellows portion (23b) and physical property values of elements that are a part of the electric wire (21), and a program that implements an analysis step that is based on a condition which stipulates a certain element or a relationship between elements; and

constructing an image in which forms of the corrugated tube and the electric wire (21) are expressed based on the calculated coordinates of some or all of the elements, wherein

the physical property value of the elements that are the part of the cylindrical portion (23a) is a numerical value approximating that the cylindrical portion (23a) is a rigid body not to be bent.

[4] A program for causing a computer to carry out each step that is included in the analysis method according to the configuration [3].

The present invention is described in detail or referring to the specific embodiment, but it is apparent to a person of ordinary skill in the art that various changes or modifications can be made without deviating from the spirit and scope of the present invention.

According to the present invention, an effect can be achieved in which the time required for one-time analysis can be shortened without increasing a precision error between a form that results when a modeled wire harness is installed to run in a certain arranged-to-run environment and a form that results when an actually manufactured wire harness is installed to run in the same arranged-to-run environment. The present invention that achieves the effect is useful for an analysis device, an analysis method, and a program in which a form of the wire harness including a corrugated tube and an electric wire positioned inside the corrugated tube is image-constructed by arithmetic operation.

What is claimed is:

1. An analysis device that image-constructs a form of a wire harness by arithmetic operation, the wire harness including a corrugated tube in which a cylindrical portion in a shape of a hollow cylinder, and a bellows portion that has side walls in which projected folds and recessed folds are repeated alternately and of which the inside is surrounded by the side walls and is in a hollow shape are connected and the wire harness further including an electric wire positioned inside the corrugated tube, the analysis device comprising:
a storage unit in which physical property values of elements that are a part of the cylindrical portion, physical property values of elements that are a part of the bellows portion and physical property values of elements that are a part of the electric wire in a modeled wire harness are stored on element basis;
a recording unit in which a program that implements an analysis step that is based on a condition which stipulates a certain element or a relationship between elements is recorded; and
an arithmetic operation unit that calculates, for all elements, coordinates of any elements when a given element is positioned at given coordinates, and constructs an image in which forms of the corrugated tube and the electric wire are expressed based on the calculated coordinates of some or all of the elements, by referring to the physical property values on the element basis stored in the storage unit and the program recorded in the recording unit, wherein
the physical property value of the elements that are the part of the cylindrical portion is a numerical value approximating that the cylindrical portion is a rigid body not to be bent.

2. The analysis device for evaluating performance of the wire harness of which the form is calculated by the analysis device according to claim 1, wherein
the physical property values of elements that are a part of the cylindrical portion, the physical property values of elements that are a part of the bellows portion and the physical property values of elements that are a part of the electric wire are stored on element basis and also an external additional condition that is externally given on the wire harness in order to evaluate the performance is further stored in the storage unit, and
the arithmetic operation unit calculates the performance in a case where the external additional condition is given to the wire harness, by referring to the physical property values on the element basis and the external additional condition, which are stored in the storage unit, and the program recorded in the recording unit, and outputs the calculated performance.

3. An analysis method that image-constructs a form of a wire harness by arithmetic operation, the wire harness including a corrugated tube in which a cylindrical portion in a shape of a hollow cylinder, and a bellows portion that has side walls in which projected folds and recessed folds are repeated alternately and of which the inside is surrounded by the side walls and is in a hollow shape are connected and the wire harness further including an electric wire positioned inside the corrugated tube, the analysis method comprising:
calculating, for all elements, coordinates of any elements when a given element is positioned at given coordinates, by referring to physical property values of elements that are a part of the cylindrical portion, physical property values of elements that are a part of the bellows portion and physical property values of elements that are a part of the electric wire, and a program that implements an analysis step that is based on a condition which stipulates a certain element or a relationship between elements; and
constructing an image in which forms of the corrugated tube and the electric wire are expressed based on the calculated coordinates of some or all of the elements, wherein
the physical property value of the elements that are the part of the cylindrical portion is a numerical value approximating that the cylindrical portion is a rigid body not to be bent.

4. A non-transitory computer-readable storage medium in which a program is stored to cause a computer to carry out each step that is included in the analysis method according to claim 3.
